(19) United States
(12) Patent Application Publication
(10) Pub. No.: US 2020/0148327 A1
(43) Pub. Date: May 14, 2020

(54) METHOD OF FORMING A HOLLOW SPAR FOR AN AERIAL VEHICLE

(71) Applicant: Asfigan Limited, Southampton Hampshire (GB)

(72) Inventors: Andrew Charles ELSON, Southampton Hampshire (GB); Douglas CAMERON, Southampton Hampshire (GB); Julian SPOONER, Southampton Hampshire (GB)

(21) Appl. No.: 16/624,660

(22) PCT Filed: Jun. 20, 2018
(86) PCT No.: PCT/GB2018/051719

§ 371 Date: Dec. 19, 2019

(30) Foreign Application Priority Data
Jun. 21, 2017 (GB) 1709891.4

(51) Int. Cl. B64C 3/20; B29C 53/38; B64C 3/18; B29B 11/14; B64F 5/10; B64C 39/02; B29L 31/30

(52) U.S. Cl. CPC B64C 3/20; B29C 53/382; B64C 3/187; B29B 11/14; B64F 5/10; B29C 2793/0081; B64C 39/024; B64C 2201/021; B64C 2201/042; B29L 2031/3085; B64C 3/185

(57) ABSTRACT

A method of forming a hollow spar for an aerofoil includes forming a sandwich structure having a first structural layer, a second structural layer and a cellular core layer located in between the first structural layer and the second structural layer. At least part of the sandwich structure is removed at intervals corresponding to one or more corner locations, and the sandwich structure is folded at the one or more corner locations to define a hollow space and form the spar. A chordwise extending rib section for an aerofoil has a substantially planar web with a chordwise length; and a reinforcement strip attached to an edge of the web over substantially the majority of the chordwise length.

### FIELD OF THE INVENTION

The present invention relates to improvements in aerial vehicles, in particular a hollow spar, a method of manufacturing the hollow spar, a rib section and a spar-to-spar joint. Also, a joint between a fuselage boom and a spar, an aerofoil comprising the hollow spar and/or rib and an aerial vehicle including the aerofoil of the invention.

### BACKGROUND OF THE INVENTION

The design of aerial vehicles is generally optimised according to the intended application or missions to be undertaken and the anticipated environmental conditions. In the case of aerial vehicles, and particularly unmanned aerial vehicles (UAVs), operating at high altitude, e.g. in the stratosphere, for extreme duration flights lasting weeks or months, the design requires close attention to a number of critical factors. Among these, minimising the weight of the vehicle and its payload in order to keep the power requirement to a minimum must be balanced with the structural strength of the vehicle and its ability to withstand loads encountered at various stages of flight, for example during take-off, landing and whilst at altitude.

Flight at stratospheric altitudes has the advantage that the stratosphere exhibits very stable atmospheric conditions, with wind strengths and turbulence levels at a minimum between altitudes of approximately 18 to 30 kilometres. This allows the external load bearing requirements of the aircraft structure in flight to be minimised, and is preferable for a variety of missions such as mapping and surveillance.

### SUMMARY OF THE INVENTION

A first aspect of the invention provides a method of forming a hollow spar for an aerofoil, the method steps comprising forming a sandwich structure having a first structural layer, a second structural layer and a cellular core layer located in between the first structural layer and the second structural layer; removing at least part of the sandwich structure at intervals corresponding to one or more corner locations; and folding the sandwich structure at the one or more corner locations to define a hollow space and form the spar.

A second aspect of the invention provides a hollow spar for an aerofoil, the hollow spar comprising a sandwich structure defining a hollow space, the sandwich structure having a first structural layer, a second structural layer, and a cellular core layer located in between the first structural layer and the second structural layer, wherein the hollow spar has a plurality of corners and a discontinuity in the sandwich structure at one or more of the corners, the discontinuity comprising a region where at least part of the sandwich structure is absent.

Advantageously, the first and second aspects allow the weight or mass of the hollow spar to be minimised, whilst maintaining sufficient load bearing capability to support the aerofoil structure that the spar may fit within.

A spar is a load bearing longitudinal beam. In an aeroplane wing the spar forms a main spanwise extending structure. The corners of the spar structure are formed at locations or areas of the sandwich structure where material has been removed and a discontinuity is thereby formed. The discontinuity is formed as a cut out. The sandwich structure is folded to form each corner at the discontinuity. Edges or sides of the discontinuity may meet at the corner once the sandwich structure is folded. Alternatively, there may be a gap or void at the discontinuity in the unfolded sandwich structure and in the hollow spar. If the edges or sides of the discontinuity are in contact in the hollow spar, the discontinuity may appear as a line in the cellular core layer and/or in the first or second structural layer.

The step of removing at least part of the sandwich structure may include removing at least part of the second structural layer and at least part of the cellular core layer. This allows the sandwich structure to fold easily to form the spar. The final shape of the hollow spar may be rectangular and folded so that the discontinuities at the corners and the second structural layer form the inside surface of the hollow spar. Alternatively, the structure could be folded so that the first structural layer forms the inside surface of the hollow spar or beam, in which case the discontinuities are located on the outer surface of the hollow spar.

The sandwich structure may be folded to form a rectangle having four corners. Alternatively, the sandwich structure may be folded to form a hollow spar with two or more corners. The sandwich structure may be folded to form a hollow spar with three or more corners.

The method may further comprise the step increasing the thickness of the first and/or second structural layers at one or more of the corner locations. The regions of increased thickness may be provided as tape wider than the discontinuity.

The first and/or second structural layer may have an overhang portion, and the step of folding the sandwich structure at the one or more corner locations may include joining the overhang portion to the sandwich structure. The overhang portion enables the spar to be formed and held together easily and without a requirement for additional fixture parts.

The first structural layer and/or the second structural layer may comprise fibre reinforced composite material. The cellular core material may comprise a structural foam material or honeycomb for example. The cellular core material may comprise one or more of polystyrene, polycarbonate, polyvinylchloride, polypropylene, acrylonitrile-butadiene-styrene or a polymethacrylimide (PMI) foam such as Rohacell™. Structural material is lightweight whilst also providing sufficient rigidity to support the static and aerodynamic loading required. The density of the cellular core material may vary across the sandwich structure.

The discontinuity in the sandwich structure of the hollow spar results from a region where at least part of the sandwich structure is absent. The discontinuity may include a region where there is an absence of at least a part of the second structural layer and at least a part of the cellular core layer. The hollow spar may further comprise regions of increased thickness of the first and/or second structural layers at one or more of the corners.

The first and/or second structural layer may have an overhang portion joined to the sandwich structure. The cellular core material may be a structural foam material. The structural foam material may comprise a cellular core foam of one or more of polystyrene, polycarbonate, polyvinylchloride, polypropylene, acrylonitrile-butadiene-styrene or a polymethacrylimide (PMI) foam such as Rohacell™. The first structural layer and/or the second structural layer may comprise fibre reinforced composite material. The hollow spar may form part of an aerofoil attached to an aerial vehicle having a wingspan of from 20 metres to 60 metres. An aerofoil may comprise the hollow spar of the second aspect.

A third aspect of the invention provides a chordwise extending rib section for an aerofoil comprising a substantially planar web having a chordwise length; and a reinforcement strip attached to an edge of the web over substantially the majority of the chordwise length.

A fourth aspect of the invention provides a method of constructing an aerofoil including a spar and one or more rib sections comprising a planar web and a reinforcement strip, the method steps comprising arranging the rib section adjacent the spar; attaching a reinforcement strip to an edge of the planar web over substantially the majority of the chordwise length such that an extension portion projects beyond the rib section.

Advantageously, the third aspect allows the weight or mass of the rib section to be minimised, whilst maintaining sufficient load bearing capability to support the aerofoil structure that the rib section may fit within. Assembling the rib to an aerofoil according to the fourth aspect again minimises the mass or weight of the aerofoil assembly and hence the aerial vehicle to which the aerofoil attaches.

The rib section may extend over a portion of the chordwise length of the aerofoil. The reinforcement strip provides additional structural rigidity and strength to the rib section. The reinforcement strip of the rib section may have an extension portion projecting beyond the rib section for attachment to a spar. The extension portion provides a simple and effective method of attaching the rib section to the spar. In preferred embodiments the reinforcement strip has two extension portions, one for attachment to an upper surface of the spar and one for attachment to a lower surface of the spar. Alternatively, the reinforcement strip may be formed as one extension portion extending over the upper and/or lower surfaces of the spar. The planar web of the rib section may have a spanwise thickness and the reinforcement strip may extend substantially across a full extent of the thickness. The reinforcement strip thereby provides additional strength and structural rigidity across the maximum spanwise thickness of the rib section. For example, the reinforcement strip may form a cap over the edge of the web. The substantially planar web may have one or more apertures. The apertures enable the weight of the rib section to be minimised. The reinforcement strips on the upper and/or lower edges of the web may be wider than the thickness of the web so as to overhang the web, forming an ‘I’ or ‘T’ beam cross section.

The reinforcement strip may comprise fibre reinforced composite material. Alternatively, any lightweight material capable of providing additional structural strength and rigidity could be used, for example wood or plastic. The reinforcement strip may be provided as tape. Tape enables the rib section to be easily manufactured and assembled to a wing of an aerial vehicle. The reinforcement strip may be planar or substantially flat tape. The reinforcement strip may be formed as a rod with a cross sectional profile shaped to fit to the edge of the planar web. The reinforcement strip may be formed into various shapes, for example the reinforcement strip may be formed as a substantially U-shape. The reinforcement strip may extend beyond the edge of the planar web. The reinforcement strip may cap the edge of the planar web on one or both sides of the edge. The reinforcement strip may be formed as a single piece or may be multiple strip sections overlaid or attached adjacent to each other. The reinforcement strip may have uniform width along its length, or alternatively the strip may have varying width along its length. The relatively wider regions of the strip may provide regions of increased stiffness as compared with relatively narrower regions of the strip where the strip width varies along the length. The edges of the strip may have an edge profile and/or be mitred.

The extension portion may be formed as a single piece with the reinforcement strip, or may be one or more additional strip sections overlaid or attached adjacent to each other and to the main reinforcement strip.

The planar web may comprise structural foam material. The structural foam material may comprise a cellular core foam of one or more of polystyrene, polycarbonate, polyvinylchloride, polypropylene, acrylonitrile-butadiene-styrene or a polymethacrylimide (PMI) foam such as Rohacell™. Structural foam results in a lightweight yet rigid rib section.

The rib section may form part of an aerofoil attached to an aerial vehicle having a wingspan of from 20 metres to 60 metres.

An aerofoil may comprise a plurality of rib sections according to the third aspect. An end of each rib section may be configured to be adjacent a spar and the extension portion may attach to at least a portion of the spar. The spar may comprise the hollow spar of the second aspect. The connecting arm member may also cooperate with a second spar of a second aerofoil. The fuselage and aerofoil may form part of an aerial vehicle having a wingspan of from 20 metres to 60 metres.

The reinforcement strip may have an extension portion, and the method of constructing an aerofoil may further comprise attaching the extension portion to the spar to attach the rib section to the spar. The spar may be formed as a hollow spar according to the first aspect.

A fifth aspect of the invention provides a joint between a fuselage boom and a spar of an aerofoil, the fuselage boom having a cross-sectional profile and a longitudinal axis, and the spar having a spanwise axis, the joint comprising a bracket located on the fuselage boom; and a connecting arm member that cooperates with the bracket and the spar to connect the spar to the fuselage boom, so that the spanwise axis is offset from the longitudinal axis and the spanwise axis is located outside the cross-sectional profile of the fuselage boom.

A sixth aspect of the invention provides a method of joining a fuselage boom to a spar of an aerofoil, the fuselage boom having a cross-sectional profile and a longitudinal axis, and the spar having a spanwise axis, the method comprising the steps of providing a bracket located on the fuselage boom; and connecting the spar to the fuselage boom by providing a connecting arm member that cooperates with the bracket and the spar, so that the spanwise axis is offset from the longitudinal axis and the spanwise axis is located outside the cross-sectional profile of the fuselage boom.

Advantageously, the joint between the fuselage boom and the spar enables a simple and effective connection between the fuselage boom and the spar of the aerofoil. This is particularly relevant where the fuselage boom and the spar are of similar dimensions; or where the fuselage boom is of a small enough diameter or dimension that any connector passing through the boom has even smaller dimensions and is therefore incapable of carrying the required loads across the joint. Passing a connector through the fuselage boom is also likely to be impractical since the boom itself is likely to be weakened to an unsatisfactory or excessive extent. In these circumstances, conventional aircraft joints provide no assistance. Additionally, where the aerial vehicle is of a size that requires modular sections to be manufactured, for example where the vehicle is larger than can be sensibly manufactured and transported as a single assembled product, it is advantageous to provide joints that allow modular sections to be easily assembled in situ prior to flight. The aerial vehicle may for example have a wingspan of between 20 and 60 metres.

A fuselage boom is an elongate, longitudinal, nacelle-like load bearing beam. The fuselage boom forms the longitudinal structure of an aircraft, to which the wings and tail assembly are attached, and may extend forward of the wings. The aircraft may have one or more fuselage booms. In an unmanned aircraft, the fuselage boom can be a small diameter tube, since there is no requirement to carry crew or passengers. The boom is typically a hollow tube and can be formed of composite material, for example carbon fibre composite, or of a metal or alloy. Whilst a tube may be the simplest form of boom, there is no requirement that a fuselage boom is circular or hollow in cross-section and the boom can take any suitable form to meet the loading demands of the fuselage application.

In order to minimise weight, the connecting arm member may be an elongate tube. The tube may have a circular or non-circular cross-sectional profile, and may be hollow or solid.

The spanwise axis of the spar is offset from the longitudinal axis of the fuselage boom. Generally, the spanwise axis may be expected to be vertically offset, with the spar, and hence the wings, located either above or below the longitudinal axis of the fuselage boom. The spanwise axis is located outside the cross-sectional profile of the fuselage boom. The cross-sectional profile of the fuselage boom is the perimeter of the shape of the boom. The profile of the fuselage boom may be that of a tube along a majority of its length. The profile of the fuselage boom does not include the profile of the bracket. The relevant cross-sectional profile of the fuselage boom may be at generally the intersection of the spanwise and the longitudinal axes.

The spar may be hollow, and the connecting arm member may extend into a hollow space of the spar to cooperate with the spar. An end of the hollow spar provides a convenient and compact space in which to house an attachment to the spar. The end of the hollow spar also enables an overlap joint between the spar and the connecting arm member to be formed. The bracket may have a hole and the connecting arm member may pass through the hole to cooperate with the bracket. A maximum dimension of the cross sectional profile of the fuselage may be substantially equal to or smaller than a maximum cross sectional dimension of the spar. The bracket may be integrally formed with the fuselage boom. This enables the number of components in the assembly to be minimised, and simplifies the assembly process. Alternatively, the connecting arm member may form part of either the spar or the bracket. The connecting arm member may be a projection on the spar. The projection may be on one of the two aerofoil portions to be connected. The bracket may have a recess rather than a through hole, and the connecting arm member may insert into and locate within the recess. The connecting arm member may alternatively be a projection located on the bracket.

The connecting arm member may also cooperate with a second spar of a second aerofoil. The fuselage and aerofoil may form part of an aerial vehicle having a wingspan of from 20 metres to 60 metres.

The spar of the aerofoil may be hollow, and the method step of engaging the spar with the connecting arm member may comprise inserting the connecting arm member into a hollow space at an end of the spar. A support bracket may locate to an end of the spar, and the connecting arm member may be adapted to locate to the support. The support may be a bulkhead inserted into the end of the spar. The bulkhead may form two or more support arms. The support arms may support the connecting arm member within the spar. The connecting arm member may be adapted to insert into or engage around an external surface of the spar.

The bracket may have a hole and the step of engaging the bracket with the connecting arm member may comprise passing at least part of the connecting arm member through the hole. A cross sectional shape of the hole and a cross sectional shape of the connecting arm member may correspond.

Alternatively, the bracket may be adapted to couple to the fuselage by one or more supporting attachments located along the length of the fuselage. The connecting arm member may be integrally formed with the bracket. A maximum dimension of the cross sectional profile of the fuselage may be substantially equal to or smaller than a maximum cross sectional dimension of the spar. The joint may further comprise a brace extending between the spar and the fuselage boom. The brace extends at an angle between the fuselage and the spar. The brace provides additional structural rigidity to the joint between the fuselage and the spar towards the trailing edge, e.g. to allow transfer of yaw and pitch loads.

The method may further comprise the step of attaching a brace to the spar and to the fuselage boom. The method may further comprise the step of attaching a second spar of a second aerofoil to the connecting arm member, so as to attach the second spar to the fuselage boom.

A seventh aspect of the invention provides a spar-to-spar joint in an aerofoil including a first spar and a second spar, the first spar having a first spar end and the second spar having a second spar end, the first spar end and the second spar end arranged adjacent one another, the spar-to-spar joint comprising: a first fixture at the first spar end, a second fixture at the second spar end, and a tether attached to the first fixture and the second fixture to join the first spar to the second spar.

An eighth aspect of the invention provides a method of joining a first spar to a second spar in an aerofoil, the first spar having a first spar end and the second spar having a second spar end, the first spar end and the second spar end arranged adjacent one another, the method comprising the steps of attaching a tether to a first fixture at the first spar end, and attaching the tether to a second fixture at the second spar end to join the first spar to the second spar.

Advantageously, a spar-to-spar joint formed by lacing adjoining spars together in this way provides a simple and secure joint which is able to flex so as to provide a degree of movement between the spars.

The first spar may comprise a first hollow space and the second spar may comprise a second hollow space, and the joint may further comprise a connecting arm member adapted to extend into the first hollow space and the second hollow space to join the first spar to the second spar. This secures the joint between adjacent spars in a direction generally perpendicular to the longitudinal axis of each spar.

The adjacent spar ends may generally oppose each other. The spar-to-spar joint may be between two adjacent spars forming an outboard portion of the aerofoil. This enables the final wingspan of the aerial vehicle to be assembled in sections, which is advantageous when the wingspan is relatively long, for example from 20 metres to 60 metres. Alternatively, the spar-to-spar joint may be formed between two inboard spars with a fuselage located between the spars. In this case, the connecting arm member is adapted to engage with a bracket located on a fuselage boom.

Each of the first and second fixtures may have a contact surface and the tether may bear against the contact surface. Lacing the spars together between the contact surface of each fixture enables the spars to be securely lashed together. The tether is attached between the fixtures such that it is in tension. The fixtures and the tether secure the joint. The fixtures and the tether hold the spars in position across the spar-to-spar joint. The tether is cord and is able to stretch slightly whilst also providing retention at the joint. The tether therefore allows some flexure at the joint so as to provide a degree of movement between the spars.

Each of the first and second fixtures may comprise an eye or loop and the tether may pass through the eye or loop. An eye or loop as the contact surface allows the tether to pass through and so be securely attached to the eye or loop. Alternatively or additionally, contact surface of each fixture may comprise a hook or a bobbin, for example, and the tether may wrap around the hook, bobbin or other contact surface in order to securely attach. The tether may wrap or loop between two fixtures once. The tether may wrap or loop between two fixtures a plurality of times in order to lace adjacent spars together. The tether may lash the spars together.

The first and second spars may form part of an aerofoil of an aerial vehicle, the aerial vehicle having a wingspan of from 20 metres to 60 metres. Constructing an aerofoil from multiple spars each having a length which may be around 9 metres, enables portions of the aerofoil to be made separately, for example for ease of handling or transportation.

There may be one spar-to-spar joint between adjacent spars, or there may be a plurality of spar-to-spar joints arranged around the end surface of each spar.

The joint may further include a connecting arm member, and the method may further comprise the steps of inserting one end of the connecting arm member into a hollow space in the first spar end, and inserting a second end of the connecting arm member into a hollow space in the second spar end.

Each of the first and second fixtures may have a contact surface and the steps of attaching a tether to the first fixture and the second fixture may include causing the tether to bear against the contact surface of the respective first or second fixture. Each of the first and second fixtures may comprise an eye or loop and the steps of attaching the tether to the first fixture and the second fixture may include passing tether through the eye or loop.

The first and second spars may form part of an aerofoil of an aerial vehicle, the aerofoil having a wingspan of from 20 metres to 60 metres.

An aerial vehicle, e.g. an unmanned aerial vehicle, may incorporate the spar of the second aspect. The aerial vehicle may incorporate the chordwise extending rib of the third aspect. The aerial vehicle may incorporate the aerofoil made according to the method of the fourth aspect. The aerial vehicle may incorporate the aircraft joint of the fifth aspect. An unmanned aerial vehicle incorporating the spar-to-spar joint according to the seventh aspect. The aerial vehicle may have a wingspan of from 20 metres to 60 metres. The aerial vehicle may further comprise at least one wing, a fuselage boom, a tail and at least one propeller powered by a motor and a power supply.

### BRIEF DESCRIPTION OF THE DRAWINGS

Embodiments of the invention will now be described with reference to the accompanying drawings, in which:

FIG. 1 is a perspective view of an exemplary unmanned aerial vehicle according to an embodiment of the invention,

FIG. 2 is a perspective, cut away view of part of an exemplary aerofoil showing the design of a spar section, and a plurality of ribs,

FIG. 3 is a perspective view of part of the exemplary aerofoil of FIG. 2 showing the aerofoil connected to a fuselage,

FIG. 4 is a schematic view of the attachment of a cross brace to the spar shown in FIG. 3,

FIG. 5a is a cross sectional view through a sandwich structure before being formed into a spar, showing first and second structural layers and a cellular core layer,

FIG. 5b is the cross sectional view of FIG. 5a once portions of the sandwich structure are removed at the corner locations,

FIG. 5c is a cross sectional view of an exemplary folded corner section, showing a discontinuity and regions of increased thickness of the first and second structural layers at an inside and outside of a corner,

FIG. 5d is an end view of the spar of FIGS. 5a-5c showing the overhang portion extending from the first layer,

FIG. 5e is a cross sectional view through the exemplary spar once fully formed, with the detail of the overhang portion and tape at the corners omitted, and

FIG. 6 is a schematic side view of a spar-to-spar joint.

### DETAILED DESCRIPTION OF EMBODIMENT(S)

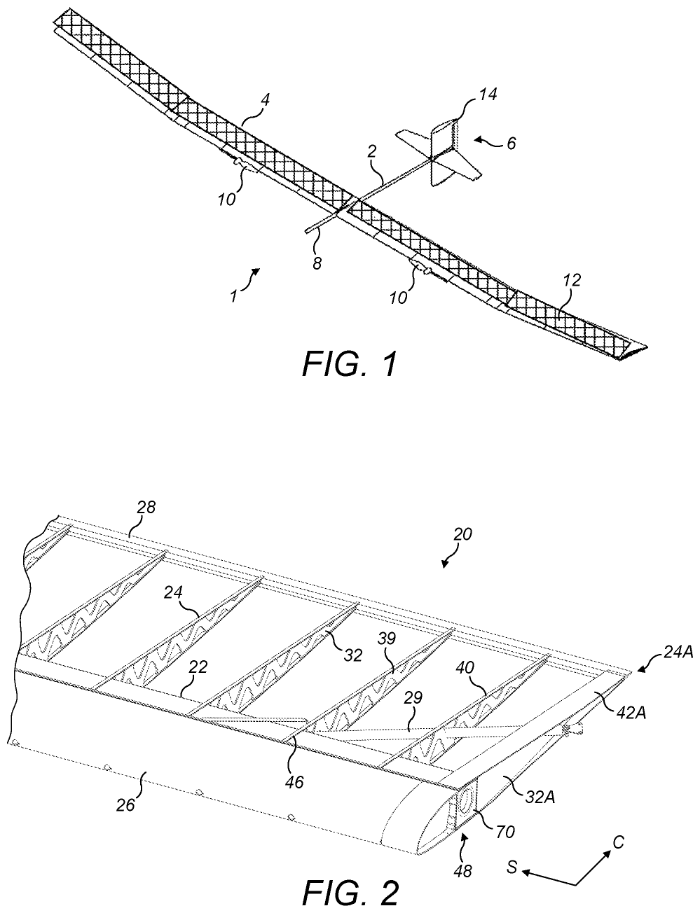

FIG. 1 shows an exemplary unmanned aerial vehicle (UAV) 1, with a fuselage boom 2 and wings 4 extending either side of the fuselage. In alternative embodiments, the aerial vehicle may have a plurality of booms and may have a variety of fuselage/wing configurations, i.e. the aerial vehicle may take any form suitable for the flight conditions at the planned altitude.

The UAV 1 illustrated in FIG. 1 is configured to be lifted to the stratosphere by a lighter than air carrier where it is released for long duration flight. The lighter than air carrier may be a balloon. In order to minimise weight, the UAV 1 has no landing gear.

The UAV 1 excluding any payload has a mass of between around 30 kg to 150 kg. The UAV 1 carries a payload, and the total weight of the vehicle is comprised of greater than around 30% payload, preferably greater than around 40% payload and more preferably greater than around 50% payload.

In this embodiment the fuselage is a boom fuselage 2 having a minimal structure, comprising simply a lightweight tube, with the wings 4 and tailplane 6 attached to the tube. The tube is of carbon fibre construction, having a diameter in the range of 60 to 120 mm and a wall section of 0.5 mm. In alternative embodiments, the fuselage may be constructed of any lightweight material, for example wood, plastic or fibre reinforced composite, and may be hollow or solid, and of any shape suitable for having wings and tailplane attached. The shape and dimensions of the fuselage 2 may vary along the length of the fuselage 2, for example to provide weight balance, and may be elliptical or tapered. The nose 8 of the fuselage extends forwards of the wings and acts to counter balance the weight of the tailplane 6.

Where a single fuselage 2 is provided, each of the wings 4 carry a motor driven propeller 10. Where multiple, parallel fuselages 2 are provided, each fuselage 2 can carry a motor driven propeller 10. Each propeller may be powered by rechargeable energy storage devices, e.g. batteries, ultracapacitors or fuels cells, or may be driven directly by solar energy collecting cells. As shown in this embodiment, the batteries or other energy storage devices may be recharged during flight via solar energy collecting cells 12. The batteries are clustered as packs held within the wing structure. The solar energy collecting cells 12 in this embodiment are located over substantially the majority of the upper surface of the wings 4. In other embodiments, solar cells 12 may be located over less of the wing surface or on the tailplane 6, according to the energy requirements in flight of the particular aerial vehicle being used. Each propeller 10 is lightweight, in an embodiment the propellers 10 each weigh less than one kilogram and are greater than 2 metres in length. The propellers 10 are shaped for high altitude, low speed flight.

The tailplane 6 has cruciform vertical and horizontal stabilising surfaces attached to the fuselage 2. The trailing portion of the vertical stabiliser has an active movable rudder 14 located at the upper and lower portion of the vertical stabilising surface. An actuator controls the rudder 14, the actuator being located in the tailplane 6. Alternatively the vertical stabiliser may be an all moving rudder. The horizontal stabiliser shown is an all moving elevator but may alternatively be a fixed horizontal stabiliser with a moveable elevator portion.

The wings 4 are elongate in a spanwise direction with a wingspan of between 20 to 60 metres. The wing 4 may be straight or tapered in the outboard direction, and the wings 4 may be horizontal or have a dihedral or an anhedral angle from the point the wing meets the fuselage, or from any point along the wing. The payload of the vehicle is also carried mainly within the wing structure in this embodiment.

Each wing 4 comprises an exemplary aerofoil 20, the design of which is shown in the cut away perspective view of FIG. 2. FIG. 2 shows the aerofoil 20 with no skin attached.

The aerofoil 20 comprises a spanwise extending spar 22, with a plurality of chordwise extending rib sections 24 attached to the spar 22 at intervals along the span. A spanwise extending leading edge arrangement 26 attaches to the spar 22, and a spanwise extending trailing edge arrangement 28 attaches to an end of each rib section 24 at the trailing edge. A brace 29 (shown in FIGS. 2 to 4) extends from the spar 22 to the fuselage 2. The following sections describe the spar, rib and aerofoil construction, as well as how the aerofoil is then attached to the fuselage.

Spar Construction

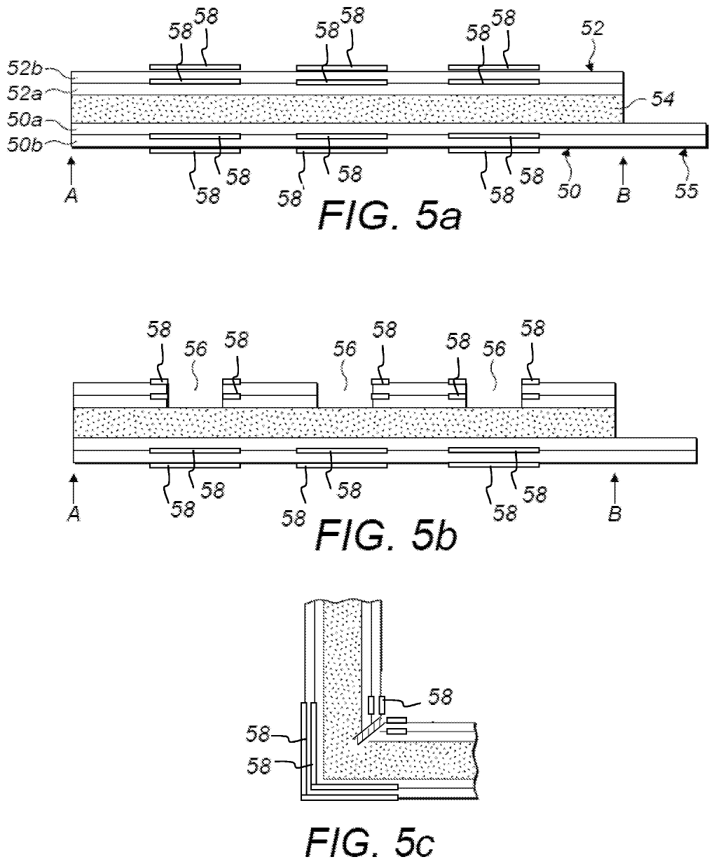

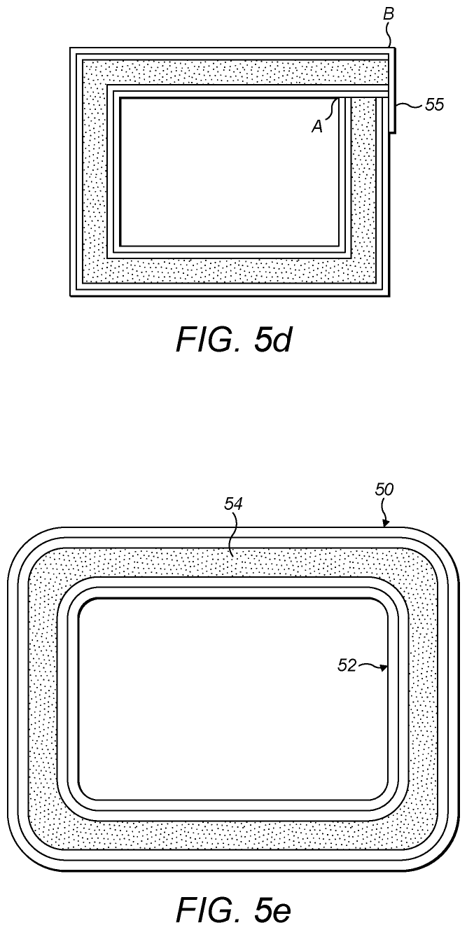

The spar 22 has a hollow beam structure, shown in cross section in FIG. 5e. The hollow beam structure comprises a sandwich structure (shown in FIG. 5a), with a first structural layer 50 and a second structural layer 52. In the current embodiment, the structural layers are formed from plies of a carbon fibre reinforced polymer material. In alternative embodiments, any lightweight and flexible material capable of providing load bearing functionality could be used, for example any alternative fibre reinforced composite such as glass fibre. The spar may have a constant section along its length, or alternatively the spar may have a tapering section along its length to align the local spar section with loads and/or local aerofoil section.

A cellular core material 54 is located sandwiched between the first 50 and second 52 structural layers. The cellular core material 54 comprises a structural foam material, which in this embodiment is a polymethacrylimide (PMI) foam such as Rohacell™. Alternative structural foam materials could be used, for example polystyrene, polycarbonate, polyvinylchloride, polypropylene, acrylonitrile-butadiene-styrene.

The hollow beam structure is formed as shown in FIGS. 5a to 5e. FIG. 5a provides a cross-sectional view through the sandwich structure, showing how the first structural layer 50 or skin is laid up. The cellular core layer 54 is then laid upon the first structural layer 50, with the second structural layer 52 laid up on top of the cellular core layer 54. The first structural layer 50 comprises two plies, a first ply 50a laid up at an angle of +45 degrees and a second ply 50b laid up at an angle of −45 degrees. Similarly, the second structural layer 52 comprises two plies, a first ply 52a laid up at an angle of +45 degrees and a second ply 52b laid up at an angle of −45 degrees. In alternative embodiments, the first and second structural layers may be formed of any number of plies and the ply directions may be varied. The first structural layer 50 has an overhang portion 55 extending beyond the sandwich structure at one end. The overhang portion 55 serves to join the formed spar or beam at each end A and B of the sandwich structure, as described in the following paragraphs.

The sandwich structure is formed as a planar sheet. A router is then used to remove material from the sandwich structure at the corner locations 56 of the spar. FIG. 5b shows how sections of the sandwich structure are cut out. In a preferred embodiment, the second structural layer and some, e.g. 1 mm, of cellular foam material are removed at intervals. This allows the sandwich structure to fold easily. Removal occurs by routing out material from the sandwich structure. FIG. 5b shows the cut outs as rectangular sections, however in alternative embodiments, the cut out may be any shape, defined by the tool and method being used to remove the material. For example, the cut out may be generally a V-shape, to allow for the sandwich structure to fold without leaving a gap in material or discontinuity at the corner. It will be readily apparent to the skilled person that there are alternative methods of forming the corner locations, for example the sandwich structure may be additively laid up as layers with discontinuities at the corner locations formed during the lay up.

The shape of the hollow spar is formed by folding the sandwich structure at the corner locations. FIG. 5c is a detailed cross section of a corner formed from the rectangular cut out in the sandwich structure as shown in FIG. 5b. There is a discontinuity 57 at the corner section due to the cut out. The material of the second structural layer and cellular foam material are brought together at the corner in the formed shape of the spar. The portions of the second structural layer either side of the cut out may be bonded together with adhesive (shown with hatched lines in FIG. 5c). The discontinuity 57 continues to exist in the cellular core layer and the second structural layer.

In the current embodiment unidirectional tape 58 is laid up within the structural layers on the inside and the outside of the corners in order to increase the stiffness of the spar. The structural layers having the unidirectional tape are then applied to either side of the foam core prior to making the cut and folding. The cut is made through the inner structural layer at least and maybe also part way through the core. The amount of tape and the location of the tape may vary according to the longitudinal bending stiffness required of the spar. The larger the discontinuity the wider the tape may be required so as to be wider than the width of the discontinuity. The tape in this embodiment is carbon fibre reinforced tape, but any other suitable reinforcing tape may also be used.

In this embodiment, the final shape of the hollow spar is rectangular and folded so that the cut outs 56 at the corners and the second structural layer 52 form the inside surface of the hollow spar or beam. In alternative embodiments, the structure could be folded so that the first structural layer 50 forms the inside surface of the hollow spar or beam, in which case the cut outs are located on the outer surface of the hollow spar or beam.

The sandwich structure in this embodiment is folded to form four corners. In an alternative embodiment, the sandwich structure may be folded to form a hollow beam or spar with two or more corners. In a further embodiment, the sandwich structure may be folded to form a hollow beam or spar with three or more corners.

The sandwich structure in its unfolded state has a first end A and a second end B as shown in FIG. 5b, and during folding the ends A and B join to define a hollow space and form a closed rectangle as shown in FIG. 5d. The overhang portion 55 of the first structural layer 50 at end B contacts the opposing end A of the first structural layer so as to join the first end A and second end B and form the hollow spar.

FIG. 5d shows the sandwich structure folded to form a square or rectangular hollow spar, and highlights how the overhang portion 55 attaches to the sandwich structure to form the finished spar. In alternative embodiments the spar may have any suitable cross sectional shape according to the particular design constraints of the aerofoil used. Additionally, any corners existing in the cross sectional shape of the spar may be sharp or rounded, and are not intended to be limited by the embodiment depicted in FIGS. 2 to 5. FIG. 5d shows a spar with sharp rather than radiused corners. In practise, each corner will have a slightly curved profile, and may have any radius suitable for manufacture of the spar or required for the functioning of the spar. The cellular core layer 54 is shown in FIGS. 5a to 5e to be thicker in cross section than either of the first 50 or second 52 structural layers. In alternative embodiments the cellular core material 54 may be thinner in relation to the first 50 and second 52 structural layers, or may be substantially the same thickness as the structural layers 50, 52. FIG. 5e shows a cross sectional representation of the final spar omitting the detail of the overhang portion.

Rib Construction

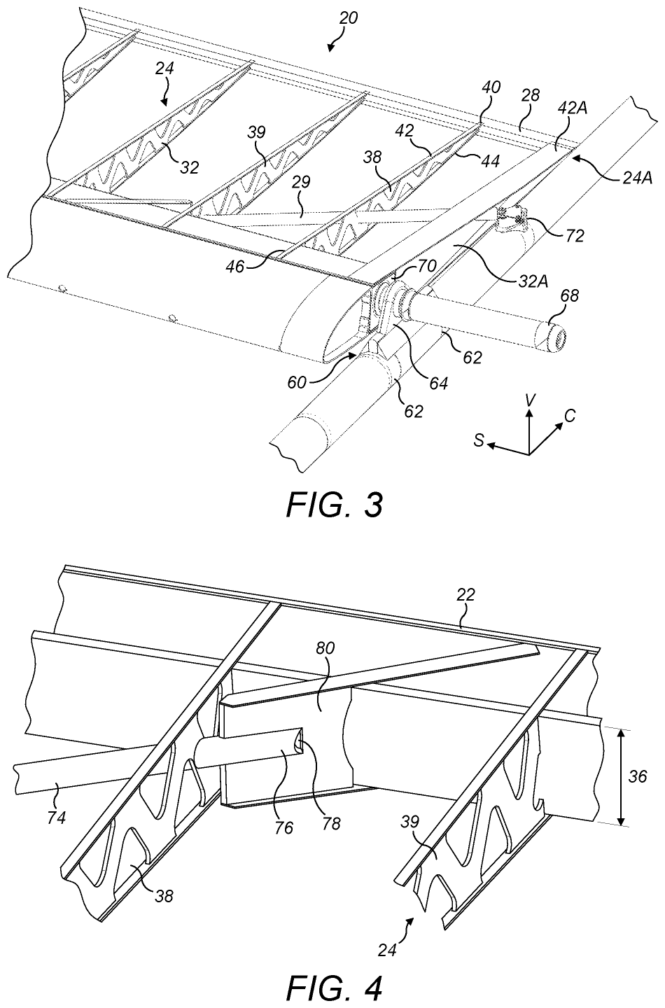

Each chordwise extending rib section 24 in FIGS. 2 and 3 comprises a planar web 32. The planar web 32 is formed of Rohacell™. Alternative structural foam materials could be used, for example polystyrene, polycarbonate, polyvinylchloride, polypropylene, acrylonitrile-butadiene-styrene or other polymethacrylimide (PMI) foams. The planar web 32 in this embodiment is cut from a sheet of the above material. In alternative embodiments, the planar web 32 may be formed or manufactured for example by additive manufacturing methods. The planar web 32 has a chordwise length extending from at the trailing edge 28 of the aerofoil 20 at one end to the spar 22 at an opposing end, near the leading edge 26 of the aerofoil 20. At the leading edge end, the planar web 32 has a height 36 in the vertical direction V shown in FIG. 4. The height 36 of the planar web 32 narrows to a tip at the trailing edge.

Returning to FIG. 3, the chordwise length of the planar web 32 has edges at upper and lower surfaces. The upper 42 and lower 44 edges support the upper and lower aerodynamic surfaces of the aerofoil. Sections of the planar web 32 are cut out or removed or formed as apertures 38 so as to create a particularly lightweight structure. In the present embodiment, each rib weighs between around 20-25 grams. The apertures 38 are approximately V- or U-shaped in this embodiment, however the apertures 38 could be of any suitable shape in order to minimise the weight of the rib section 24. The material of the rib section 24 that remains once the apertures 38 are formed provides a series of struts 39 serving to maintain the integrity and strength of the rib.

In order to provide reinforcement, a reinforcement strip or batten 40 is attached to the upper 42 and lower 44 edges of the planar web 32. In this embodiment the batten 40 is provided as a strip of sandwich material. The sandwich strip is a structural foam core between two layers of carbon fibre reinforced composite material. In other embodiments other forms of fibre reinforced composite material may be used, for example glass fibre. The planar web 32 has a spanwise S thickness at the upper 42 and lower 44 edges and the reinforcement strip or batten 40 extends over substantially the thickness of the planar web 32. In other embodiments, the strip or batten 40 may extend over the upper 42 and lower 44 edges for only a portion of the length of the planar web 32, or extend over only the upper 42 or lower 44 edge, or over only a partial thickness of the planar web 32, or extend beyond the thickness of the planar web 32 to form rib flanges. The reinforcement strip or batten 40 in this embodiment is substantially planar. In other embodiments, the reinforcement strip or batten 40 may be applied as a flexible tape or solid strip of reinforcement material, and may be formed into various planar or non-planar shapes. For example, the reinforcement strip or batten 40 may extend from the edge of the planar web so as to cap the edge. A reinforcement strip with a U-shaped profile may be convenient to achieve this.

Part of the reinforcement strip or batten 40 extends beyond the rib section 24 in the chordwise direction C. This extension portion 46 serves to attach the rib section 24 to the spar 22, as will be explained below. The extension portion 46 may be formed on both or one of the upper 42 or lower 44 edges of the planar web 32.

Aerofoil Construction

The aerofoil 20 is assembled by arranging the rib section 24 with the rib web 32 arranged substantially vertically adjacent the spar 22. The leading edge 26 end of the planar web 32 is arranged adjacent the spar 22, and the extension portion 46 of the reinforcement strip or batten 40 is attached to the spar 22. The extension portion in this embodiment is bonded to the spar 22. In this embodiment, each extension portion 46 extends to overlay the upper surface and lower surface of the spar. Each rib section 24 is attached to the spar 22 at spanwise intervals in a similar manner.

As best shown in FIG. 2, the spanwise end 48 of the aerofoil portion 20 has a final rib section 24A wider than the inner rib sections 24. The web of the final rib section 24A comprises two portions: a rib web with cut outs (similar to the rib web 32) on the inboard side (not visible in the Figures), a solid rib web on the outboard side. The solid rib web 32A has a carbon sandwich construction with carbon fibre skins sandwiching a structural foam core. Upper and lower battens 42A, wider but otherwise structurally similar to the battens 40, of carbon fibre and structural foam sandwich is attached to the upper and lower edges the final rib section 24A. The solid rib web 32A extends diagonally from the outboard edge of the spar 22 to the inboard side of the trailing edge of the battens 42A.

The leading edge 26 is formed of a series of leading edge ribs (only one of which is visible in the Figures) covered in a shell of extruded polystyrene. Each section between the ribs is able to hold batteries or payload. In this embodiment, the leading edge is bonded to the spar 22.

The trailing edge component 28 is a foam prism or wedge wrapped in carbon fibre which extends forwardly to form a lower flange. The trailing edge extension of the reinforcement strip or batten 40 on the upper edge of each rib section 24, 24A is tapered towards the trailing edge by terminating the structural foam core of the strip or batten 40, 42A such that the two carbon fibre layers come together as a single layer, which is bonded to the trailing edge component 28. The trailing edge extension of the reinforcement strip or batten 40 on the lower edge of each rib section 24, 24A is not tapered and overlaps the lower flange of the trailing edge component 28 and is bonded to it at the overlap region.

In order to reach the required wing span of 20 metres to 60 metres, the aerofoil is made in spanwise extending portions (approx. 9 metres wide), which are then assembled together. The assembly comprises a joiner tube inserted into the end of the spar 22. The end of each spar 22 has two bulkheads spaced apart which supports the joiner tube.

The inboard portion of the aerofoil 20 additionally has a brace 29 shown in FIGS. 2 to 4 extending at an angle between the spar 22 and the fuselage 2. The brace 29 comprises a carbon fibre reinforced tube 74 attached at one end to the fuselage 2 and at an opposing end to the spar 22. The tube 74 passes through the apertures 38 of one or more rib sections 24, shown in FIGS. 3 and 4.

The aerofoil has a cover (not shown) supported by the spar and rib sections. The cover comprises a pre-stressed membrane. Solar panels 12 are incorporated into the aerofoil 20 upper surface and attached to the membrane.

Joining the Aerofoil to the Fuselage

The boom fuselage 2 is tubular in this embodiment and of a diameter similar in size to the cross sectional height or diagonal dimension of the spar 22. The joint connecting the fuselage 2 to the aerofoil portions 20 offsets the spanwise axis of the spar 22 from the longitudinal axis of the fuselage 2. This allows the aerofoil portions 20 to be attached to the fuselage vertically offset from the fuselage. The offset is in the vertical direction V. The offset places the wings 4 above the fuselage 2 in this embodiment, however other configurations are possible. In one alternative embodiment, the wings 4 could be located offset below the fuselage 2.

The fuselage 2 has a bracket 60 attached at a position on the fuselage 2 that correlates to the required attachment location for the spar 22. The aerofoil 20 is thereby positioned on the fuselage 2. In this embodiment, the bracket 60 is attached by straps 62 to the fuselage 2. In alternative embodiments, the bracket may be integrally formed with the fuselage. The bracket forms a lug 64 having a hole through which a connecting arm member 68 passes.

The connecting arm member 68 in this embodiment is a joiner tube. The joiner tube 68 has a circular cross sectional profile. In alternative embodiments a number of different cross sectional profiles are possible—the hole in the lug 64, and the joiner tube 68, having corresponding cross sectional profiles, in order to provide effective location of the joiner tube 68 to the bracket 60, and hence the fuselage 2.

The joiner tube 68 connects to the aerofoil 20 via the spar 22. The spar 22 has a support 70 located in a longitudinal end of the spar 22, as best shown in FIG. 2. In this embodiment the support 70 is a bulkhead. The bulkhead 70 comprises two partitions (not shown) located within the longitudinal end of the spar 22. The joiner tube 68 inserts into the longitudinal end of the spar 22. The partitions support the joiner tube 68 at two locations along the length of the joiner tube 68, providing accurate and effective connection. Alternatively, the joiner tube 68 may insert over an external surface of the longitudinal end of the spar 22.

The joiner tube 68 has two ends, enabling one aerofoil portion to be connected at each end of the joiner tube 68. Two aerofoil portions are thereby attached, one portion on either side of the fuselage 2.

In alternative embodiments, the connecting arm member 68 may form part of either the spar 22 or the bracket 60. The connecting arm member 68 may be a projection on the spar 22. The projection may be on one of the two aerofoil portions to be connected. The bracket 60 may have a recess rather than a through hole, and the connecting arm member may insert into and locate within the recess. The connecting arm member 68 may alternatively be a projection located on the bracket 60.

In order to secure the joint towards the trailing edge of the aerofoil, the brace 29 shown in FIGS. 2 to 4 extends at an angle between the spar 22 and the fuselage 2. A rose joint 72 is strapped or otherwise attached to the fuselage in a similar manner to the bracket 60 of the joint between the fuselage 2 and the spar 22. The rose joint 72 allows the angle of the brace to be adjusted. In alternative embodiments, the rose joint may be replaced by any joint capable of attaching the brace to the fuselage.

The brace 29 is attached by a rose joint 72 to the fuselage. FIG. 4 shows the attachment of the tube 74 of the brace 29 to the spar 22. An end 76 of the tube 74 inserts into a recess 78 in a structural foam block 80. The block 80 has a height approximately equal to a height of the spar 22 in the vertical direction V. The block 80 has carbon fibre reinforced tape attached along an upper 82 and a lower 84 edge, extending along a length of the block 80. Similarly to the rib sections 24, the tape extends beyond the length of the block 80 at the spar end, and fastens to the spar 22.

Lacing Adjacent Spars Together

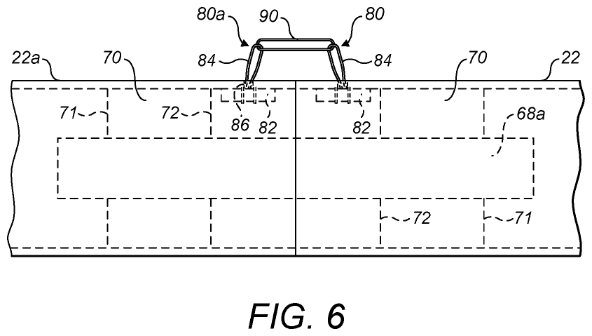

FIG. 6 is a schematic side view of a joint between two adjacent spars 22, 22a in the UAV 1. The joint may be at the join between port and starboard wings 4, or at the join between adjacent spar sections within a wing 4. Adjacent spars are assembled in this manner in order to provide a final wing span which may be anywhere between 20 and 60 metres in length.

Each spar 22, 22a is hollow, as described above. The spars are assembled by inserting a joiner tube 68a into adjacent ends of neighbouring spars. The joiner tube 68a is similar in shape and dimensions to the joiner tube 68 described above. The joiner tube 68 illustrated in FIG. 3 is part of the joint that joins spars 22 of the wings 4 to the fuselage 2. The spar-to-spar joint shown in FIG. 6 is an outboard joint between two spars within a single wing 4, and thus does not also include a fuselage to spar joint. The joint may, for example, be located at the opposing, outboard end of the spar 22, which has its inboard end attached to the fuselage. Alternatively, the joint may be between any two further spars which form part of the final aerofoil. The joint connects adjacent or neighbouring spar ends to each other. Where the joint includes the fuselage to spar joint described above and also two connects two spars, then these adjacent spars are also laced together as described below.

The end of each spar 22, 22a has a bulkhead 70 which supports the joiner tube 68a. The bulkhead 70 is inserted into the end of each spar 22, 22a and sits slightly recessed within the spar end. The bulkhead 70 comprises two partitions 71, 72 located within the end of the spar 22. Each partition 71, 72 comprises a web extending between an upper and a lower inside surface of the spar 22, 22a. Each partition 71, 72 has an aperture. The joiner tube 68a is inserted into the end of the spar 22 and extends through the aperture of each partition 71, 72. The partitions 71, 72 thereby support the joiner tube 68a at two respective locations along the length of the joiner tube 68a, providing an accurate and effective connection between the joiner tube 68a and the spar 22, 22a. In alternative embodiments, an external surface of the end of the spar 22, 22a may instead be inserted into an open end of the joiner tube 68a to achieve a connection therebetween.

Adjacent spars 22, 22a are also laced together, as shown schematically in FIG. 6. A fixture 80 is located generally at each opposing end of each spar 22, 22a. In the illustrated embodiment, the fixture comprises an elongate bar 82 with a loop 84 attached. The loop 84 is made of cord. The loop of cord 84 is attached to the elongate bar 82 at one end. In the illustrated embodiment, the loop of cord is simply passed over the bar 82 and looped through itself to achieve the attachment to the bar. The opposing end of the loop forms an eye through which a tether 90 passes, as described below. There are a number of alternative methods by which a loop can be formed, which will be familiar to the skilled person and so are not described in detail here. The elongate bar may be formed of metal, plastic or any rigid material capable of anchoring the loop of cord. The loop may not be cord in other embodiments, the loop may for example be wire or be formed from metal or plastic as a rigid eye.

The elongate bar 82 anchors the loop 84 to the spar 22, 22a. The elongate bar 82 remains on the inside of the hollow spar 22, 22a and the loop of cord 84 passes through a small hole 86 so that it protrudes beyond the external surface of the spar 22, 22a. Each fixture 80 is located towards the end of the spar 22, 22a.

In order to join the spars 22, 22a together a tether 90 is laced between neighbouring fixtures 80. The tether 90 passes through the loop 84 of the first fixture 80 at a first end of one of the spars 22 and extends through the loop 84 of a second fixture 80 located in the region of a second spar end of the other spar 22a. The tether 90 is attached between the fixtures such that it is in tension. The fixtures 80 and the tether 90 thus together secure the joint. The fixtures 80 and the tether 90 hold the spars in position across the spar-to-spar joint. The tether 90 may connect the first and second fixtures 80 via a single length of cord extending between the first and second fixtures; or may be looped around the first and second fixtures as shown by the schematic illustration in FIG. 6. The tether 90 may alternatively be laced between the first and second fixtures 80 multiple times so that the tether 90 comprises multiple (i.e. two or more) lengths or loops in order to provide the joint.

The tether is made from cord and is able to stretch slightly under tension whilst also providing retention at the joint. The tether therefore allows a degree of relative movement between the spars 22, 22a at the joint. The tether 90 may be made of any type of cord material or wire capable of maintaining the spar-to-spar joint whilst also allowing some flexure.

The design of the fixture may alternatively be varied. For example, rather than an eye through which the tether passes, each fixture may comprise a hook. The tether may pass through the hook and be held in place by the curve of the hook alone. Alternatively, the tether may be wrapped or looped around the hook in order that the tether is held more securely by the fixture. In a further design, a bobbin arrangement may provide the attachment portion for the tether. The bobbin may be formed by a projection which is cylindrical or of any suitable cross-sectional shape. The projection may have a flange at an end opposing the surface of the spar, which extends beyond the projection in a generally perpendicular direction. The flange serves to retain the tether as it attaches to the bobbin. The tether may be held in place by the flange or may be wrapped around the bobbin projection.

The various possible fixture designs have in common that there is a contact surface between the fixture and the tether, and the tether bears against the contact surface in order to provide a secure attachment.

FIG. 6 shows one spar-to-spar joint present for each pair of adjoining spars 22, 22a. Alternatively, there may be a plurality of joints present between each pair of adjoining spars.

Where a spar is attached to the fuselage as shown in FIG. 3 and an adjacent spar is also attached to the opposing end of the connecting arm member 68, the adjacent spars so formed are also laced together using the spar-to-spar joint described above.

Although the invention has been described above with reference to one or more preferred embodiments, it will be appreciated that various changes or modifications may be made without departing from the scope of the invention as defined in the appended claims.

1-59. (canceled)

60. A method of forming a hollow spar for an aerofoil, the method steps comprising:
forming a sandwich structure having a first structural layer, a second structural
layer and a cellular core layer located in between the first structural layer and the second structural layer;
removing at least part of the sandwich structure at intervals corresponding to one or more corner locations; and
folding the sandwich structure at the one or more corner locations to define a hollow space and form the spar.

61. A method according to claim 60, wherein the step of removing at least part of the sandwich structure includes removing at least part of the second structural layer and at least part of the cellular core layer.

62. A method according to claim 60, wherein the step of forming the sandwich structure includes increasing the thickness of the first and/or second structural layers at one or more of the corner locations.

63. A method according to claim 60, wherein the first and/or second structural layer has an overhang portion, and the step of folding the sandwich structure at the one or more corner locations includes joining the overhang portion to the sandwich structure.

64. A method according to claim 60, wherein the first structural layer and/or the second structural layer comprise fibre reinforced composite material.

65. A method according to claim 60, wherein the cellular core material comprises a structural foam material.

66. A method according to claim 65, wherein the cellular core material comprises one or more of polystyrene, polycarbonate, polyvinylchloride, polypropylene, acrylonitrile-butadiene-styrene or a polymethacrylimide (PMI) foam such as Rohacell™.

67. A hollow spar for an aerofoil, the hollow spar comprising a sandwich structure defining a hollow space, the sandwich structure having a first structural layer, a second structural layer, and a cellular core layer located in between the first structural layer and the second structural layer, wherein the hollow spar has a plurality of corners and a discontinuity in the sandwich structure at one or more of the corners, the discontinuity comprising a region where at least part of the sandwich structure is absent.

68. A hollow spar according to claim 67, wherein the region of the discontinuity includes an absence of at least a part of the second structural layer and at least a part of the cellular core layer.

69. A hollow spar according to claim 67, further comprising regions of increased thickness of the first and/or second structural layers at one or more of the corners.

70. A hollow spar according to claim 67, wherein the first and/or second structural layer has an overhang portion joined to the sandwich structure.

71. A hollow spar according to claim 70, wherein the cellular core material is a structural foam material.

72. A hollow spar according to claim 67, wherein the cellular core material comprises one or more polystyrene, polycarbonate, polyvinylchloride, polypropylene, acrylonitrile-butadiene-styrene or a polymethacrylimide (PMI) foam such as Rohacell™.

73. A hollow spar according to claim 67, wherein the first structural layer and/or the second structural layer comprise fibre reinforced composite material.

74. A hollow spar according to claim 67, wherein the hollow spar forms part of an aerofoil attached to an aerial vehicle having a wingspan of from 20 metres to 60 metres.

75. An aerofoil comprising the hollow spar of claim 67.

76. A chordwise extending rib section for an aerofoil comprising:
a substantially planar web having a chordwise length; and
a reinforcement strip attached to an edge of the web over substantially the majority of the chordwise length.

77. A rib section according to claim 76, wherein the reinforcement strip has an extension portion projecting beyond the rib section for attachment to a spar.

78. A rib section according to claim 76, wherein the planar web has a spanwise thickness and the reinforcement strip extends substantially across a full extent of the thickness.

79. A rib section according to claim 76, wherein the substantially planar web has one or more apertures.

80. A rib section according to claim 76, wherein the reinforcement strip comprises fibre reinforced composite material.

81. A rib section according to claim 76, wherein the reinforcement strip is provided as tape.

82. A rib section according to claim 76, wherein the planar web comprises structural foam material.

83. A rib section according to claim 82, wherein the structural foam material comprises a cellular core foam of one or more of polystyrene, polycarbonate, polyvinylchloride, polypropylene, acrylonitrile-butadiene-styrene or a polymethacrylimide (PMI) foam such as Rohacell™.

84. A rib section according to claim 76, wherein the rib section forms part of an aerofoil attached to an aerial vehicle having a wingspan of from 20 metres to 60 metres.

85. An aerofoil comprising a plurality of rib sections according to claim 76.

86. An aerofoil according to claim 85, wherein an end of each rib section is configured to be adjacent a spar and the extension portion attaches to at least a portion of the spar.

87. An aerofoil according to claim 86, wherein the spar is hollow and comprises a sandwich structure defining a hollow space, the sandwich structure having a first structural layer, a second structural layer, and a cellular core layer located in between the first structural layer and the second structural layer, wherein the hollow spar has a plurality of corners and a discontinuity in the sandwich structure at one or more of the corners, the discontinuity comprising a region where at least part of the sandwich structure is absent.

88. A method of constructing an aerofoil including a spar and one or more rib sections comprising a planar web and a reinforcement strip, the method steps comprising:
arranging the rib section adjacent the spar; and
attaching a reinforcement strip to an edge of the planar web over substantially the majority of the chordwise length such that an extension portion projects beyond the rib section.

89. A method according to claim 88, wherein the reinforcement strip has an extension portion, and the method further comprises attaching the extension portion to the spar to attach the rib section to the spar.

90. A method according to claim 89, wherein the spar is formed as a hollow spar by:
forming a sandwich structure having a first structural layer, a second structural
layer and a cellular core layer located in between the first structural layer and the second structural layer;
removing at least part of the sandwich structure at intervals corresponding to one or more corner locations; and
folding the sandwich structure at the one or more corner locations to define a hollow space and form the spar.

91. A joint between a fuselage boom and a spar of an aerofoil, the fuselage boom having a cross-sectional profile and a longitudinal axis, and the spar having a spanwise axis, the joint comprising:
a bracket located on the fuselage boom; and
a connecting arm member that cooperates with the bracket and the spar to connect the spar to the fuselage boom, so that the spanwise axis is offset from the longitudinal axis and the spanwise axis is located outside the cross-sectional profile of the fuselage boom.

92. A joint according to claim 91, wherein the spar is hollow, and the connecting arm member extends into a hollow space of the spar to cooperate with the spar.

93. A joint according to claim 91, wherein the bracket has a hole and the connecting arm member passes through the hole to cooperate with the bracket.

94. A joint according to claim 91, wherein a maximum dimension of the cross sectional profile of the fuselage is substantially equal to or smaller than a maximum cross sectional dimension of the spar.

95. A joint according to claim 91, wherein the bracket is integrally formed with the fuselage boom.

96. A joint according to claim 91, wherein the connecting arm member also cooperates with a second spar of a second aerofoil.

97. A joint according to claim 91, wherein the fuselage and aerofoil form part of an aerial vehicle having a wingspan of from 20 metres to 60 metres.

98. A method of joining a fuselage boom to a spar of an aerofoil, the fuselage boom having a cross-sectional profile and a longitudinal axis, and the spar having a spanwise axis, the method comprising the steps of:
providing a bracket located on the fuselage boom; and
connecting the spar to the fuselage boom by providing a connecting arm member that cooperates with the bracket and the spar, so that the spanwise axis is offset from the longitudinal axis and the spanwise axis is located outside the cross-sectional profile of the fuselage boom.

99. A method according to claim 98, wherein the spar is hollow, and the step of engaging the spar with the connecting arm member comprises inserting the connecting arm member into a hollow space in the spar.

100. A method according to claim 98, wherein the bracket has a hole and the step of engaging the bracket with the connecting arm member comprises passing at least part of the connecting arm member through the hole.

101. A method according to claim 98, further comprising the step of attaching a second spar of a second aerofoil to the connecting arm member, so as to attach the second spar to the fuselage boom.

102. A spar-to-spar joint in an aerofoil including a first spar and a second spar, the first spar having a first spar end and the second spar having a second spar end, the first spar end and the second spar end arranged adjacent one another, the spar-to-spar joint comprising:
a first fixture at the first spar end,
a second fixture at the second spar end,
and a tether attached to the first fixture and the second fixture to join the first spar to the second spar.

103. A joint according to claim 102, wherein the first spar comprises a first hollow space and the second spar comprises a second hollow space, and the joint further comprises a connecting arm member adapted to extend into the first hollow space and the second hollow space to join the first spar to the second spar.

104. A joint according to claim 103, wherein each of the first and second fixtures has a contact surface and the tether bears against the contact surface.

105. A joint according to claim 102, wherein each of the first and second fixtures is an eye or loop and the tether passes through the eye or loop.

106. A joint according to claim 102, wherein the first and second spars form part of an aerofoil of an aerial vehicle, the aerial vehicle having a wingspan of from 20 metres to 60 metres.

107. A method of joining a first spar to a second spar in an aerofoil, the first spar having a first spar end and the second spar having a second spar end, the first spar end and the second spar end arranged adjacent one another, the method comprising the steps of:
attaching a tether to a first fixture at the first spar end, and
attaching the tether to a second fixture at the second spar end to join the first spar to the second spar.

108. A method according to claim 107, wherein the joint further includes a connecting arm member, and the method further comprises the steps of :
inserting one end of the connecting arm member into a hollow space in the first spar end, and
inserting a second end of the connecting arm member into a hollow space in the second spar end.

109. A method according to claim 107, wherein each of the first and second fixtures has a contact surface and the steps of attaching the tether to the first fixture and the second fixture include causing the tether to bear against the contact surface of the respective first or second fixture.

110. A method according to claim 107, wherein each of the first and second fixtures comprises an eye or loop and the steps of attaching the tether to the first fixture and the second fixture include passing the tether through the eye or loop.

111. A method according to claim 107, wherein the first and second spars form part of an aerofoil of an aerial vehicle, the aerofoil having a wingspan of from 20 metres to 60 metres.

112. An unmanned aerial vehicle incorporating the spar of claim 67.

113. An unmanned aerial vehicle incorporating the chordwise extending rib of claim 76.

114. An unmanned aerial vehicle incorporating the aerofoil of claim 85.

115. An unmanned aerial vehicle incorporating the aircraft joint of claim 91.

116. An unmanned aerial vehicle incorporating the spar-to-spar joint according to claim 102.

117. An unmanned aerial vehicle according to claim 112, wherein the unmanned aerial vehicle has a wingspan of from 20 metres to 60 metres.

118. An unmanned aerial vehicle according to claim 112, further comprising at least one wing, a fuselage boom, a tail and at least one propeller powered by a motor and a power supply.
